(19) United States
(12) Patent Application Publication
(10) Pub. No.: US 2014/0280001 A1
(43) Pub. Date: Sep. 18, 2014

(54) SYSTEMS AND METHODS FOR ORGANIZING, PRESENTING, AND RETRIEVING INFORMATION ABOUT ITEMS OF INTEREST IN A SOCIAL NETWORK OF INTERESTS

(71) Applicant: GearSay, Inc., Winchester, MA (US)

(72) Inventor: Jeffrey A. STEIN, Winchester, MA (US)

(21) Appl. No.: 14/209,189

(22) Filed: Mar. 13, 2014

Related U.S. Application Data
(60) Provisional application No. 61/784,589, filed on Mar. 14, 2013.

(51) Int. Cl. G06F 17/30

(52) U.S. Cl. CPC G06F 17/30864
USPC 707/706

(57) ABSTRACT

In one aspect, the present disclosure relates to a system for organizing, presenting and retrieving information about items of interest in a social network of interests including a user database for storing personal attributes of a plurality of users and an interest list for each of the plurality of users, the interest list comprising a plurality of interests; a plurality of personal profiles for presenting the personal attributes in the user database and the interest lists for each of the plurality of users; and a search engine, in communication with the user database and plurality of personal profiles, for performing an interest query of the user database, the interest query returning information relevant to the interest, the information relevant to the interest comprising at least one of an additional user, a posting by an additional user relating to the interest, or an additional interest related to the interest.

This application claims priority under 35 U.S.C. §119(e) to U.S. Provisional Application No. 61,784,589, filed Mar. 14, 2013, entitled “Method and System for Organizing, Presenting and Retrieving Product Information,” the contents of which are incorporated by reference herein.

### BACKGROUND

1. Field of the Disclosure

The present disclosure relates to a method and system for organizing, presenting and retrieving information about items of interest.

2. Description of Related Art

Traditionally, when people bought a product or service, they went to a physical store and made a purchase based on the availability of items and recommendations from the salespeople at the store. However, online shopping provides people with a much greater number of options than traditional physical stores. People can buy products or services directly from manufacturers, retailers, or other people. People can buy from merchants around the world at any time. Accordingly, the items people can select are no longer limited by physical access.

This may make it difficult for people to make good decisions when they are purchasing new products or services. Sometimes, in order to identify the right product or service to purchase, people may look for reviews of known alternatives and decide which one to buy. However, this process is limiting because it applies only to products or services already known to the purchaser or identified through a random discovery process that typically involves a cumbersome series of separate steps including asking their friends who own similar products or have used similar services or who have extensive knowledge in the field for their opinions, searching online through product-centric or service-centric listings or browsing inventory of online or brick and mortar retail stores. But it can be difficult to know who, beyond a person's online or offline direct connections, actually owns a given product or service or what those owners' personal expertise related to the product or service might be, and if it is known, it might be hard to reach the expert.

### SUMMARY

In one aspect, the present disclosure relates to a system for organizing, presenting and retrieving information about items of interest in a social network of interests. In some embodiments, the system can include a user database for storing personal attributes of a plurality of users and an interest list for each of the plurality of users, the interest list comprising a plurality of interests; a plurality of personal profiles for presenting the personal attributes in the user database and the interest lists for each of the plurality of users; and a search engine, in communication with the user database and plurality of personal profiles, for performing an interest query of the user database, the interest query returning information relevant to the interest, the information relevant to the interest comprising at least one of an additional user, a posting by an additional user relating to the interest, or an additional interest related to the interest. In some embodiments, the interest can include one of a product, a service, a place, another user, or an event. In some embodiments, the system can include an interest database for storing the interest and user-provided or interest-provided information about the interest. In some embodiments, the information about the interest can include vendor-provided information for the interest. In some embodiments, the system can include a plurality of interest profiles for presenting information in the interest database, each interest profile comprising information for a corresponding interest. In some embodiments, the interest database can include a user list for each interest. In some embodiments, the user list can include a plurality of users related to the interest.

In another aspect, the present disclosure relates to a method for organizing, presenting and retrieving information about items of interest, in a social network of interests. In some embodiments, the method includes storing in a user database personal attributes of a plurality of users and an interest list for each of the plurality of users, the interest list comprising a plurality of interests; providing a plurality of personal profiles for presenting the personal attributes in the user database and the interest lists for each of the plurality of users; electronically receiving an interest query from a user; and executing the interest query of the user database, the interest query returning information relevant to the interest, the information relevant to the interest comprising at least one of an additional user, a posting by an additional user relating to the interest, or an additional interest related to the interest. In some embodiments, the interest can be one of a product, a service, a place, another user, or an event. In some embodiment, the method can include storing in an interest database the interest and user-provided or interest-provided information about the interest. In some embodiments, the information about the interest can include vendor-provided information for the interest. In some embodiments, the method can include providing a plurality of interest profiles for presenting information in the interest database, each interest profile can include information for a corresponding interest. In some embodiments, the interest database can include a user list for each interest. In some embodiments, the user list can include a plurality of users related to the interest.

In an embodiment of the present disclosure, a system for organizing, presenting and retrieving interest information is provided. The system includes a personal database for storing personal attributes and an interest list for a plurality of users. The interest list includes a list of owned items, a wish list, and a list of owned items available for sale. The system also includes an interest database for storing vendor-provided information, user-provided product information, and a list of owners for a plurality of interests. The system also includes a plurality of personal profiles, each personal profile for presenting information of a corresponding user in the personal database. The system also includes a plurality of interest profiles, each interest profile for presenting information of a corresponding interest in the interest database.

In another embodiment, the vendor-provided interest information is objective data published by a vendor. This vendor-provided product information can include a product name, model number, barcode, product stock keeping unit (SKU), date of production, size, weight, MSRP, components, ingredients, accessories, colors, operating conditions, configurability, warranty, testing data, other technical specifications, and sales and marketing information.

In a further embodiment, the user-provided interest information is data that each user provides based on his or her experience with the interest. User-provided interest information can also be generated by sensors or other third party sources or by the system. The user-provided interest information can include pictures, reviews, questions and answers, websites, frequency and other usage data, date of purchase, date of last usage, ratings, purchase price, and retailers from which products were purchased.

In an embodiment of the present disclosure, a method for organizing, presenting and retrieving interest information is provided. The method includes providing a plurality of interest profiles, each interest profile for presenting information of a corresponding interest of a plurality of interests. The method also includes providing a plurality of personal profiles. Each personal profile presents physical or other attributes and an interest list of a corresponding user of a plurality of users. The interest list includes a list of owned items, a wish list, and a list of owned items available for sale. The method further includes receiving user-provided interest information from a user, identifying an interest of the plurality of interests based on the user-provided interest information, listing the identified interest to a personal profile corresponding to the user, and listing the user to an interest profile corresponding to the identified interest.

In a further embodiment, the method also includes receiving vendor-provided interest information for an interest and adding an interest profile corresponding to the interest.

In another embodiment, the method also includes receiving a query message from the user and sending the query message to at least one other user. Optionally, at least one other user or category of users to receive the query message is selected by the user.

In yet another embodiment, the method includes providing a link to purchase the product.

### BRIEF DESCRIPTION OF DRAWINGS

FIG. 1 illustrates a diagram showing a system environment for organizing, presenting and retrieving interest information according to an embodiment of the present disclosure.

FIG. 2 illustrates components of a server within the system for organizing, presenting and retrieving interest information according to an embodiment of the present disclosure.

FIG. 3 illustrates a flow diagram for adding interest information provided by users according to an embodiment of the present disclosure.

FIG. 4 illustrates a flow diagram for retrieving interest information according to an embodiment of the present disclosure.

FIG. 5 illustrates a personal profile page according to an embodiment of the present disclosure.

FIG. 6 illustrates an interest profile page according to an embodiment of the present disclosure.

FIG. 7 illustrates a personal profile page of an exemplary system of the present disclosure.

FIG. 8 illustrates a format for displaying information about the products, places and things offered on the site.

FIG. 9 illustrates a format for displaying information about the user related to particular sports.

FIG. 10 illustrates a format for collecting profile information.

FIG. 11 illustrates a format for collecting information relevant to the user's specific interests.

FIG. 12 illustrates a company profile page of an exemplary system of the present disclosure.

FIG. 13 illustrates a format for enabling a user to ask questions and provide answers relevant to the user's specific interests.

FIG. 14 shows the question appearing in the feed of users who have the relevant Boston Marathon tag in their profile.

FIG. 15 illustrates a format for enabling a user to search for people, places and things relevant to his interest.

FIG. 16 demonstrates the system's performance as a social network of interests by displaying a format for the return of information relevant to that interest.

### DETAILED DESCRIPTION

The present disclosure provides a method and system for organizing, presenting and retrieving interest information. These interests can include a product, a service, a place, a venue, another user or an event. Exemplary services can include coaching, massage, therapies, bike maintenance, travel services, including but not limited to hotels, airlines, etc. Exemplary places can include destinations, resorts, etc. Exemplary events can include athletic events, e.g., BOSTON MARATHON®, social event, media events, or political events. In some embodiments, interests can also be what other users have posted about a particular service, place, product, or event. The present disclosure provides users a platform to share their experience of owning and using particular interests. Users can view what other people own, have used, or have had experience with, and how those users rated their interests. Users also can perform a search to see who owns certain products or share certain interests, including personal attributes of those owners, and how those individuals rated those specific or interests. Users can also search other users to see what interests they own and/or are have experience with. The system also can provide statistics of each interest and user in the system. The system also can allow users to send query messages to other users, requesting information on an interest, including before purchasing the product or service, visiting a particular place or participating in a particular event. Throughout this disclosure, the term “item” is also used to refer to an “interest.”

FIG. 1 shows a system environment 100 for presenting and viewing interest profiles according to some embodiments of the present disclosure. The system environment 100 includes a plurality of client devices 101A, 101B, 101C, 101D connected through Internet 103 (or any other computer network) to a server 105.

Client devices 101A-D can be computers or other mobile devices, for example, smartphones or tablet computers. Users can use client devices 101A-D to communicate with server 105 via one or more computer networks such as Internet 103. Protocols and components for communicating via the internet are well-known to those of ordinary skill in the art of computer network communications. Communication between client devices 101A-D and server 105 also may be enabled by local wired or wireless computer network or cellular data connections. In another embodiment, server 105 and client devices 101 may exist within the same network connected by intranet or any other computer network, rather than by internet.

The system environment 100 depicted in FIG. 1 can operate in a distributed computing environment including several computer systems that are interconnected via communication links, e.g., using one or more computer networks or direct connections. However, it will be appreciated by those of ordinary skill in the art that the system 100 can equally operate in a computer system having fewer or greater number of components than are illustrated in FIG. 1. Thus, the depiction of the system environment 100 in FIG. 1 should be taken as exemplary, and not limited to the scope of the present disclosure.

It is also possible that server 105 is not a single computing unit. Similar to the system environment, server 105 can be multiple server nodes based on a distributed computing environment. The multiple server nodes also can be run in one facility or in multiple facilities.

Server 105 can include the software, databases, and associated communications routines and protocols essential to their interoperability and communications. Server 105 is generally responsible for providing front-end user communications with various user devices, such as client devices 101, hosting and running software packages that deliver the process functionality, and back-end communications with servers from sponsors of interests, such as product manufacturers, service providers, event directors, and location owners.

FIG. 2 illustrates an exemplary server 205. Server 205 can contain two databases: a personal database 280 and an interest database 290. Personal database 280 includes personal attributes 281, a list of owned items 282, a wish list 283, and a list of owned items available for sale 284 of the users. Interest database 290 can include interest-provided interest information 291, user-provided interest information 292, and an owner list 293, which can also include users who want rather than own the respective interest.

In an embodiment of the present disclosure, personal database 280 of the system stores and provides data for personal profiles of users on the system. The system provides users an interface to create personal profiles that contain interests that are searchable and analyzable. In the personal profile page, the users can list items they own, have used or experienced (stored in owned items 282 on personal database 280), want (stored in wish list 283 on personal database 280), or have available for sale (stored in owned items available for sale 284 on personal database 280) The profile owner can let other users view the items, and communicate directly with the profile owner about the items. By providing a personal profile page for each user, the system creates searchable and analyzable interest catalogs organized around people, rather than around manufacturers, retailers, or service providers. Users also can rate or write reviews of or otherwise comments on the items that are available to other users. The list of items may be available only to certain users (e.g., friends and family), the entire users of the system, or the public. The entirety or any part of personal profile pages can be shared through social media.

In another embodiment, users also can store their personal attributes 281 to the personal profiles. Some of the personal attributes can be, but are not limited to, heights, weights, ages, gender, income, skill levels associated with relevant interests (e.g., a handicap level in golf, years of experience, and professional or amateur status, etc.), hobbies, favorite sports, favorite songs, and favorite food. The personal attributes also can be available to certain users, the entire users of the system, or the public. The system may be configured to have different privacy settings for different attributes, or the system may have one privacy setting for all personal attributes.

In another embodiment, interest database 290 stores and provides interest information. In some embodiments, the interest information can be a manufacturer product profile page (a page that may show a single product or multiple products of a single or multiple manufacturers). Users can interact with the product profile page to find information on particular products. This database may provide interest-provided interest information 291 and user-provided interest information 292 to product profile pages. In some embodiments, the interest provided information related to the interest can be information provided by a service provider, an event, or a location/destination. Interest database 290 also can store an owner list 293 and present it on interest profile pages. This owner list can contain links to the specific people who own, want, or wish to sell the interest, so that others users can view the owners of the interest and communicate directly with the owners about the interest. It is possible that nobody owns or is associated with an interest or no one has rated the interest. In this case, no such information is saved on interest database 290. However, the system may save a memory space as a placeholder. The entirety or any part of an interest profile page can be shared through social media.

Vendor-provided product information is objective data published by a manufacturer, retailer or service provider. This information may include a product name, model number, barcode, product stock keeping unit (SKU), date of production, size, weight, MSRP, components, ingredients, accessories, colors, operating conditions, configurability, warranty, testing data, and other technical specifications. It may also include sales and marketing information provided by the vendor. On the other hand, user-provided product information is data that each user provides based on his or her experience with the interest. User-provided data can also be generated by sensors or other third party sources or by the system. User-provided interest information can include pictures, reviews, questions and answers, websites, frequency and other usage data, date of purchase, date of last usage, ratings, purchase price, and retailers from which products were purchased.

In an embodiment, the personal database 280 and the interest database 290 are cross-linked with each other. Owned items 282, wish list 283, or owned items available for sale 284 can be linked to interest profile pages of interest database 290. Similarly, owner list 293 and user-provided interest information 292 can be linked to personal profile pages of personal database 280. The databases also can allow for multi-dimensional statistical analyses, e.g., cross-tabulation analysis. There can be two dimensional or higher dimensional matrix of data, where users represent one dimension and interests represent another dimension. The dataset within the matrix can be interests associated with users. For example, the i^{th} row and j^{th} column of matrix M, M(i,j), can be a number of an interest i owned by a user j. Alternatively, the dataset may be other user-provided interest information, including a frequency of usage, date of purchase, date of last usage, ratings, and purchased price. Each of the dataset can be elements in another dimension.

FIG. 3 shows a flow diagram 300 of the process of adding an interest into the system. Process 300 includes receive vendor-provided interest information 310; receive user-provided interest information 320; identify interest in user-provided interest information 330; add interest to user profile 340; and add user to interest profile 350. The steps of the process are not limited to the order presented, but can be in a different order. For example, steps 310 and 320 could be reversed.

In step 310, the system receives vendor-provided interest information. There can be many ways the vendor-provided interest information is entered. First, vendors, service providers, event directors, etc., may provide their interest information to the system voluntarily or upon request. Second, users or system administrator may add complete interest-provided interest information. Third, users enter some elements of interest-provided interest information, and the system or system administrators obtains the rest of the interest information, either by requesting to manufacturers, retailers, service providers, event directors, or searching available databases. Once the information is received, the system creates an interest profile page for each of the interests and allows users to post their own interest information.

In step 320, users can provide their own information about interests. When users try to add interests that are not on the system, users may add the interest-provided interest information or request the system administrators to add the information. In this case, the process starts at step 320 and proceeds to step 310. The system may prevent users from entering interests that are not in the interest database or have system administrators validate the information.

In step 330, the system identifies and/or associates user-provided interest information with interest-provided interest information. The system may ask users to give names of products, barcodes, or other codes by the vendor, so that the system can associate user-provided interest information with interest-provided interest information. This method allows the system to quantify and aggregate information entered by multiple users. For example, if two users add pictures and ratings of the same bike, SPECIALIZED VENGE®, and if the system did not associate the user-provided interest information with the bike, the system would not be able to aggregate the information. Without the identification and aggregation, users may not be able to find the ratings, pictures, or statistical information about an interest.

Alternatively, when a user provides interest information, the system may automatically identify the interest and automatically create a new interest profile page or associate it with the correct pre-existing interest page. This identification and association process can be standardized through searching a URL, code scanning technique (e.g., a UPC code that users attach to images manually or other codes embedded by the manufacturer and retailers), or image recognition technique.

Image recognition can be based on image recognition software. The image recognition software may first recognize an image and compare this image with other images of existing products. When the image is substantially similar to other existing images of a particular interest, the image may be identified as the interest. If the image is not recognized as substantially similar to other images of existing interests, the image may be identified as a new interest or isolated for further analysis. The system may code the image with a UPC or other coding system to facilitate future identification and analysis.

In step 340, the system adds the interest information received from users or manufacturers, retailers, service providers, event planners, etc., to user profiles. For example, if a user indicates that he or she owns a particular product, the product is added to the list of items associated with the user in his or her personal profile page. Or, if a user indicates that she has used a particular service or visited a particular venue, that service or venue is added to the list of interests associated with the user. In step 350, the system adds the users who provided interest information to the interest profiles. For example, the users are added to the list of owners/users for a particular interest in its interest profile page. The steps 340 and 350 can be performed in parallel or in series without a specific order.

Because of this aggregation of collected data, the system can analyze information statistically, including a percentage of the population on the system that is associated with a given interest, number of people who have provided pictures for the interest, usage data, a combination of interests being used together, or duration of ownership/association. The system also can display statistics of each interest within the interest profile page or user profile page and further display physical and other attributes of the owners, reviews, and ratings. The data for a interest can be combined with data for any one or more interests, for example, to show how one or more users use one or more interests in combination with any one or more other interests.

In an embodiment of the present disclosure, the system also can offer its data to manufacturers, retailers and other vendors. The data from the system can give information not captured in the sales data or registration data, otherwise collected by manufacturers and retailers, because of added user preferences. The user preference data can include who is using the interests, the personal attributes and the other information in user profiles of the owner, what other interests users use in combination with the interests, and how frequently the person or persons use it. The system gives vendors data that shows the entire characteristics of the owners—as opposed to seeing only what specific interest a person has registered. The system can give vendors specific interest data in combination with personal attributes (e.g., height/weight, etc.) and listings of other interests associated with that person of that manufacturer, service provider, event director, venue, etc. or any other manufacturer. The system also can provide a graph of items that are co-owned by users. This may aid manufacturers and users to easily visualize what interests are typically used together. Information may be collected at the specific user level or across any categories or subcategories of users.

In an embodiment, the system also can provide a measure of similarity between the users. This measure of similarity can be based on users' physical attributes, skill or experience levels, personal preferences, income, geographic locations, use of venues (such as golf courses played), products they own, or other identifiable factors. This similarity measure allows a user to search for items that are owned, wanted, or available for sale by people who are similar to himself/herself or to a person for whom he or she may want to purchase a gift. This can be useful to assist people in selecting interests that are most appropriate for themselves or for persons for whom they are buying gifts. For example, people of higher skill levels in a given activity may prefer one product whereas people of a different skill level may prefer a different, but similar product. There could also be preferences based on age, weight, skill level, or other attributes.

In an embodiment, the system can also permit users to browse personal databases either based on a review of all available personal databases or filtered by the components of the personal database, including personal attributes, owned items, wanted items, or owned items available for sale. This type of searching and browsing enables a user to identify interest and other preferences of users with attributes similar to his or her own or to a person for whom he or she may be purchasing a gift.

When a user is looking to buy a certain product or attend a specific event, race, etc., he or she may send a query message to other users for their opinions and recommendations. This query message can be sent to a particular user, a particular group of users, or all of the users of the system. The selection of recipients can be manual by the user or automatic by the system. The group of users can be friends or all persons associated with a certain interest. Alternatively, the user or the system may select the most knowledgeable person regarding the interest, a group of users who are willing to respond regarding the particular interest, or other users whom the user has previously corresponded. Alternatively, the user or the system may select other users based on the measure of similarity. Also, the user or the system may send the query message to everyone who owns the item or everyone who reviewed the item. The system also may display comments and previous reviews on the page. The system can send notifications or the query to the users so they can respond on a timely basis.

This ability to query allows a user searching for an interest to “pull” reviews from users associated with that interest at the time he requests the review. Then the requester can receive the up-to-date opinions and reviews of the interest. Typically, people post reviews after a certain period of owning a product, at a time in the reviewer's ownership cycle unknown to the person reading the review. But since the post, their opinions can change either in positive or negative manners leaving the reviews outdated. The present system allows for the most up to date review of interests from the most knowledgeable people regarding that interest and also enables a reviewer to be asked a specific question by the person seeking the review.

Users may flag certain items or certain categories of items if they are willing to provide feedback. Because people have expertise in certain products, services, events, brands or fields, having a preferred list to provide feedback may allow requesters to send query messages only to experts or other people who are interested in participating in the information exchange. Alternatively, users may have an option to opt-out of query messages regarding particular interests or during a specific time period. This can be useful when users think that they do not have enough information about the interests or, for example, do not want to receive query messages during their vacations.

The system can create an efficient workflow for users to retrieve interest information, send a query, and purchase a product or service. FIG. 4 illustrates a flow diagram for retrieving interest information. Process 400 includes receive interest information from user 410; receive other users' personal attributes user 415; identify interest 420; present interest profile 440; and send query message 450. The steps of the process are not limited to the order presented, but can be in a different order. For example, steps 410 and 415 could be reversed.

In step 410, a user can first provide information to identify the interest, similar to providing user-provided interest information in Step 320. When a user is viewing an interest from external websites, he or she can provide the URLs to the system. Also, a user can provide picture or barcode of the interest to the system. This can be useful if the user is at a store looking to purchase an item. The user can also provide other interest information to the system.

In step 415, a user can provide information to identify other users with attributes of interest. This is useful if the user is looking for products, services, events, etc. that may be useful to a person with attributes like himself or herself, or if he or she is looking to buy a gift for a person with specific attributes.

In step 420, the system identifies the interest based on the information received from the user. Similar to identifying step of 330, the identification process can be performed based on searching a URL, code scanning technique, or image recognition technique. If the user provided a model name, number, barcode, or other interest-provided interest information, the system can simply compare the information with the information available on the interest database.

The system may ask the user to confirm if the interest is correctly identified. If the identified interest is different from the interest of user's interest, the system may ask the user to provide more interest information to better identify the interest. In this case, the process returns to step 410, and the system receives more interest information. Otherwise, the system will present an interest profile page in step 440. Within the interest profile page, the user can see who already owns or wants or is associated with the interest and who is offering the interest for sale. The user also can read previous reviews, comments and questions or answers from other users. Also, the user can send a query message to other users in step 450 directly from the interest profile page. The interest profile page may include a link to online stores or other users selling the interest, reducing the extra workflow required to purchase the item.

The following examples and descriptions apply the system of the present disclosure in a field of sports gear. However, the generalized principles of earlier descriptions also can be applied to other types of interests.

FIG. 5 illustrates a personal profile page of an exemplary system of the present disclosure. A personal profile page 500 contains user profile windows 511 and 512, a social media window 515, a product window 535, a product picture 538, and a product addition button 533. Personal profile page 500 includes personal information and items the person owns. Personal profile page 500 is a sample page for a triathlete and the gear that this triathlete owns.

User profile windows 511 and 512 display certain of the user's attributes in addition to the name and picture of the person. The personal attributes on user profile window 511 include the user's experience, race classification, achievements, and the state and country of residence. The user profile window 511 also includes his website and twitter account information. On user profile window 512, community rating of the user and recent achievements are displayed. Other attributes, including weight, height, age, and skill levels may be displayed to other users, or may be hidden depending on the privacy preference.

Social media window 515 provides a method for users to connect to other users. Users can add another user as a friend, share their own or another person's personal profile page with others, or send a message to the user of the profile page. The system also can provide a method for users to follow other users including tracking the activities of other users such as adding a new product to their personal profile or offering a product for sale to other users. The system also allows users to form groups, which can be formed around a specific topic or interest, including for example to discuss best practices or training tips around commonly owned gear.

On product window 535, items the user owns are listed. Furthermore, the user profile can identify items that the user wants to own. The user profile can also identify which of these products are available for sale by the user. The products in a category of owned, wanted or owned and available for sale can either be separately categorized or identified by distinguishing features such as different colored borders around the pictures of the products. On product window 535, two categories of items—swim and bike categories—are displayed separately. There can be more categories of items. Alternatively, all of the products can be grouped and displayed uncategorized or in one location. The layout of the product pictures within product window 535 can be made manually by the user or a manufacturer or can be chosen by the system based on an algorithm.

Product picture 538 shows a picture of a product. In this example, a picture of the bike model-named VENGE® from the manufacturer SPECIALIZED® is displayed. Product picture 538 can be a default picture provided by the manufacturer or a user-provided picture. The choice of product picture 538 can be made manually by the user or a manufacturer or can be chosen by the system based on an algorithm.

Product addition button 533 allows users to add the particular gear to their own personal profile page. This can add the product to a wish list, a list of owned products, or a list of owned products available for sale. Separate buttons can be configured for adding products to different lists.

FIG. 6 illustrates a single product profile page of an exemplary system of the present disclosure. A product profile page 600 contains a product description window 631, a product rating window 651, a query message window 671, a recommend button 661, an owner list 621, and a product addition button 633. Product profile pages can also include combinations of products offered by a single or multiple manufacturers and can include other manufacturer-provided and user-provided information.

Product description window 631 shows a picture and name of the product. It also displays price information, links to other social media networks, and a link to a merchant website. Product description window 631 also can display other manufacturer-provided product information.

Product rating window 651 displays the users' ratings of the product. The product is rated based, for example, on design, value, performance, and durability. There can be independent ratings for each of the categories as presented, or there also can be a combined rating. Product rating window 651 also includes a rating button that allows users to rate the product. The rating system can include other criteria and may include other statistical data about the product including, for example, statistics showing the popularity of the product in relation to others, whether on an aggregate basis or on the basis of specific personal attributes such as height, weight, age and skill level.

Query message window 671 enables users to send a query message to other users. Users can type their query on the query message window 671 and click the “Ask Your Question” button to send the query message. The system may present a way for users to select the recipients within query message window 671 or a subsequent messaging window and may display queries received and answers given on the particular product.

Recommendation button 661 enables users to recommend the particular product and if the user is not currently logged in requires him or her to log in or to create a user profile in order to participate. Owner list 621 shows a list of owners of the product on the product profile page. Users can click through the images of the owners in order to learn more about the user including his or her personal attributes and other products on his or her personal profile page. Product addition button 633 allows users to add the particular gear to their own personal profile page.

FIG. 7 illustrates a personal profile page of an exemplary system of the present disclosure. Personal profile page 700 is a sample page for an athlete and the products or services that this athlete owns and/or wants and his interests. Personal profile page 700 contains a profile window 711, a product and brand window 712 and a window that shows the user's interests 715. Profile window 711 includes personal information about the user. Attributes, including weight, height, age, and skill levels may be displayed to other users, or may be hidden depending on the privacy preference. Profile window 711 also shows the status of the user, which can be professional, coach, amateur or other status. Profile window 711 also allows other users visiting this user's profile to connect with the user or send him or her a message, as well as to see the user's TWITTER® feeds and FACEBOOK® page.

Product and brand window 712 shows the products and brands that the user owns or wants. The user profile can also identify which products are available for sale by the user. On product and brand window 712, all of the products can be grouped and displayed uncategorized or can be filtered based on sport, brand, interest (e.g., BOSTON MARATHON®) or other category. The layout of the product pictures within product and brand window 712 can be made manually by the user or a company or can be chosen by the system based on an algorithm.

Window 715 displays items of interest relevant to the user's profile, such as events, groups, products, brands, coaches, places and teams and postings by the user such as videos, photos, links and text. The items displayed in window 715 can be grouped and displayed uncategorized or can be filtered based on sport, brand or other category. The layout of the items within window 715 can be chosen by the system based on an algorithm or displayed randomly.

FIG. 8 illustrates a format for displaying information about the products, places and things offered on the site. For example, FIG. 8 depicts a page 800 for a CERVELO P4® triathlon bike 802. Users can see a description of the item and a listing of users in the system who own or want the item “Who Has It” 806, can see questions and comments posed by other users or ask their own questions or post their own comments (“Questions & Answers” 808 & “Ask a Question” 810), and can share the item with other users. Users can also add the item to their own personal profiles. Users can click through the images of the other users in the system who own or want the item in order to learn more about the user including his or her personal attributes and other products, places and things on his or her personal profile page.

FIG. 9 illustrates a format 900 for displaying information about the user related to particular sports. The information can be specific to a single sport or can relate to multiple sports. The information can consist of the user's preferences related to specified interests, or can consist of other personal attributes such as years in sport, race classification, golf handicap or other information. The information can be found by other users on search and can be aggregated for statistical purposes. For example, FIG. 9 shows various attributes of athlete “Jeff Stein” 902, for “triathlon” 904 including “Teams” 906, “Favorite Race Distances” 908, “Events” 910, “Favorite Place” 912, “Years in Sport” 914, “Gear”916, “Coach” 918 and “Favorite Store” 920.

FIG. 10 illustrates a format for collecting profile information 1000. The user can provide information about himself or herself that can be found by other users on search. The information can include information such as weight 1002, height 1004, age 1006, name 1008, gender 1010, college 1012, zip code 1014 and other information relevant to the user. Such information may be displayed to other users, or may be hidden depending on the privacy preference.

FIG. 11 illustrates a format for collecting information relevant to the user's specific interests 1100. FIG. 11 displays specific sports in which the user is involved. By clicking on the EDIT YOUR PROFILE button 1102, a user can add information relevant to his or her sport which can be found by other users on search. Users can build and add to their profiles by adding sports. Sports can be added from sports already included in the system, or can be added to the system by the user. For example, sports can include alpine skiing, running, triathlon, and road cycling/biking.

FIG. 12 illustrates a company profile page 1200 of an exemplary system of the present disclosure. Company profile page 1200 is a sample page for a company and the products or services that this company offers for sale and promotional and other information. Personal profile page 1200 contains a profile window 1211, a product and services catalog window 1212 and a window that shows promotional and other information displayed by the company 1215. Profile window 1211 includes information about the company. Attributes, including company locations, interests served and sponsored athletes may be displayed to users, or may be hidden depending on the company preference. Profile window 1211 also shows the category of the company's product or services offerings (such as “brand”, “coach”, “place” or “services”) or other status. Profile window 1211 also allows users visiting this company's profile to connect with or follow the company or send it a message, as well as to see the company's twitter feeds and Facebook page.

Product and services window 1212 shows the products and services that the company offers for sale. On product and services window 1212, all of the products and services can be grouped and displayed uncategorized or can be filtered based on sport, interest (e.g., used in Boston Marathon) or other category. The layout of the product pictures within product and services window 1212 can be made manually by the company or can be chosen by the system based on an algorithm. Information about products and services listed in product and services window 1212 are displayed to the user in more detail in the manner shown in FIG. 8 above.

Window 1215 displays promotional and other information relevant to the company, such as events, product announcements, white papers, affiliate relationships, sponsored athletes, and postings by the company such as videos, photos, links and text. The items displayed in window 1215 can be grouped and displayed uncategorized or can be filtered based on sport, interest (e.g., relevant to athletes in the Boston Marathon) or other category. The layout of the items within window 1215 can be chosen by the system based on an algorithm or displayed randomly.

FIG. 13 illustrates a format for enabling a user to ask questions and provide answers relevant to the user's specific interests 1300. FIG. 13 displays a question that has been directed to the feed of users who have a specific interest in their profile 1302 (e.g., the BOSTON MARATHON®), thereby ensuring that the question will be answered by the most informed users in the system. By adding a tag to the question, a user can be sent to other users through the system's messaging service or through the users' feeds or found by other users on search of an interest.

FIG. 14 shows the question appearing in the feed of users who have the relevant BOSTON MARATHON® tag in their profile 1400.

FIG. 15 illustrates a format for enabling a user to search for people, places and things relevant to his interest 1500. For example, the present disclosure allows users to search for something or someone that interests a user (e.g., “marathon,” “Vail,” a pro, coach or competitor's name, “golf” or a gear item) and find everything about those people, places and things. For example, search of “Vail” may allow the user to find skis to use at Vail, training videos that will help the user have more fun at Vail, hotels to stay at in Vail, and other skiers who ski there.

FIG. 16 demonstrates the system's performance as a social network of interests by displaying a format for the return of information relevant to that interest 1600. The items displayed in FIG. 16 can be grouped and displayed uncategorized or can be filtered based on sport, brand or other category. The layout of the items within FIG. 16 can be chosen by the system based on an algorithm or displayed randomly.

Embodiments of the disclosed subject matter can be implemented in computer hardware, firmware, and/or computer programs executed on programmable computers, servers, or other mobile devices (e.g., smartphones and tablet computers) that each includes a processor and a storage medium readable by the processor (including volatile and non-volatile memory and/or storage elements). Any computer program can be implemented in a high-level procedural or object-oriented programming language to communicate within and outside of computer-based systems. Any computer program can be stored on an article of manufacture, such as a storage medium (e.g., CD-ROM, hard disk, or magnetic diskette) or device (e.g., computer peripheral), that is readable by a general or special purpose programmable computer for configuring and operating the computer when the storage medium or device is read by the computer to perform the functions of the embodiments. The embodiments, or portions thereof, also can be implemented as a machine-readable storage medium, configured with a computer program, where, upon execution, instructions in the computer program causes a machine to operate to perform the functions of the embodiments described above.

Embodiments of the disclosed subject matter can be used in a variety of applications. Although the embodiments, or portions thereof, are not limited in this respect, the embodiments, or portions thereof, can be implemented with memory devices in microcontrollers, general purpose microprocessors, digital signal processors (DSPs), reduced instruction-set computing (RISC), and complex instruction-set computing (CISC), among other electronic components. Moreover, the embodiments, or portions thereof, described above also can be implemented using integrated circuit blocks referred to as main memory, cache memory, or other types of memory that store electronic instructions to be executed by a microprocessor or store data that may be used in arithmetic operations.

The descriptions herein are applicable in any computing or processing environment. The embodiments, or portions thereof, may be implemented in hardware, software, or a combination of the two. For example, the embodiments, or portions thereof, may be implemented using circuitry, such as one or more of programmable logic (e.g., an ASIC), logic gates, a processor, and a memory. While several particular forms of the disclosed subject matter have been described, it will be apparent that various modifications are possible. It is not intended that the disclosed subject matter be limited to the particular embodiments described here. Other advantages and novel features of the disclosed subject matter may become apparent from the detailed description when considered in conjunction with the drawings.

The above-presented description, including screen shots, pseudo-code, variables, elements and/or algorithmic steps, figures, images and illustrations is intended by way of example only and is not intended to limit the disclosed subject matter in any way. It is particularly noted that the persons skilled in the art can readily combine the various technical aspects of the various exemplary embodiments described, as well as their constituent elements and sub-systems, to implement features and processes contemplated to be within the scope of the disclosed subject matter but not literally or explicitly described.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception upon which this disclosure is based may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

A “server,” “client,” “agent,” “module,” “interface,” and “host” is not software per se and includes at least some tangible, non-transitory hardware that is configured to execute computer readable instructions.

As will be apparent to one of ordinary skill in the art from a reading of this disclosure, the present disclosure can be embodied in forms other than those specifically disclosed above. The particular embodiments described above are, therefore, to be considered as illustrative and not restrictive. Those skilled in the art will recognize, or be able to ascertain, using no more than routine experimentation, numerous equivalents to the specific embodiments described herein. The scope of the invention is as set forth in the appended claims and equivalents thereof, rather than being limited to the examples contained in the foregoing description.

We claim:

1. A system for organizing, presenting and retrieving information about items of interest in a social network of interests the system comprising:
a user database for storing personal attributes of a plurality of users and an interest list for each of the plurality of users, the interest list comprising a plurality of interests;
a plurality of personal profiles for presenting the personal attributes in the user database and the interest lists for each of the plurality of users; and
a search engine, in communication with the user database and plurality of personal profiles, for performing an interest query of the user database, the interest query returning information relevant to the interest, the information relevant to the interest comprising at least one of an additional user, a posting by an additional user relating to the interest, or an additional interest related to the interest.

2. The system of claim 1, wherein the interest comprises one of a product, a service, a place, another user, or an event.

3. The system of claim 1 comprising an interest database for storing the interest and user-provided or interest-provided information about the interest.

4. The system of claim 3, wherein the information about the interest comprises vendor-provided information for the interest.

5. The system of claim 3 comprising a plurality of interest profiles for presenting information in the interest database, each interest profile comprising information for a corresponding interest.

6. The system of claim 3, wherein the interest database comprises a user list for each interest.

7. The system of claim 6, wherein the user list comprises a plurality of users related to the interest.

8. A method for organizing, presenting and retrieving information about items of interest, in a social network of interests the method comprising:
storing in a user database personal attributes of a plurality of users and an interest list for each of the plurality of users, the interest list comprising a plurality of interests;
providing a plurality of personal profiles for presenting the personal attributes in the user database and the interest lists for each of the plurality of users;
electronically receiving an interest query from a user; and
executing the interest query of the user database, the interest query returning information relevant to the interest, the information relevant to the interest comprising at least one of an additional user, a posting by an additional user relating to the interest, or an additional interest related to the interest.

9. The method of claim 8, wherein the interest comprises one of a product, a service, a place, another user, or an event.

10. The method of claim 8 comprising storing in an interest database the interest and user-provided or interest-provided information about the interest.

11. The method of claim 10, wherein the information about the interest comprises vendor-provided information for the interest.

12. The method of claim 10 comprising providing a plurality of interest profiles for presenting information in the interest database, each interest profile comprising information for a corresponding interest

13. The method of claim 10, wherein the interest database comprises a user list for each interest.

14. The method of claim 13, wherein the user list comprises a plurality of users related to the interest.
